(19) United States
(12) Patent Application Publication
(10) Pub. No.: US 2021/0083246 A1
(43) Pub. Date: Mar. 18, 2021

(54) Unit comprising an electric battery and a casing

(71) Applicant: ECO CONCEPT MARINE, LA FERTE BERNARD (FR)

(72) Inventors: Benjamin ETTIENNE, SAINT-PAVACE (FR); Philippe VIGOUROUX, CHALON SUR SAÔNE (FR)

(21) Appl. No.: 17/022,704

(22) Filed: Sep. 16, 2020

(30) Foreign Application Priority Data
Sep. 16, 2019 (FR) 19 10183

(51) Int. Cl. H01M 2/10; H01M 2/12

(52) U.S. Cl. CPC H01M 2/1077; H01M 2/1264

(57) ABSTRACT

A unit is provided having an electric battery and a casing placed around the battery. The casing has a receptacle (3) and a cover (4) capable of covering said receptacle (3) in order to demarcate an internal space, into which the battery is placed. The receptacle (3) has nesting means (60) capable of engaging with matching nesting means (33, 34) of the cover (4), so as to form a continuous and stabilized chain of at least two units (1).

### RELATED APPLICATION

This application claims the benefit of French Patent Application No. 19 10183, filed on Sep. 16, 2019, the entirety of which is incorporated for reference.

### DESCRIPTION OF RELATED ART

The present invention relates to a unit comprising an electric battery and a casing. In general, an electric battery comprises a plurality of cells mounted in series and/or in parallel. When this battery is used in a fixed location, such as a house, or in a movable location, such as an electric propulsion vehicle, it can be exposed to an external environment such as, for example, rain, that is likely to degrade it or to distort its operation. It can also experience an unintentional impact or be subject to significant temperature variations. In order to overcome these potential risks of damage or degradation, the battery is generally housed in a protective casing conforming to the shape of said battery as closely as possible. Within the scope of the invention, this casing is assumed to be inseparable from the battery and therefore is not designed to be able to be separated from said battery by simple manipulation with a common commercially available tool.

A unit according to the invention comprises a multipurpose casing allowing said unit to be easily stored with other units so as to optimize their spatial requirement, whilst keeping the battery housed in said unit fully operational.

It is assumed that an electric battery of a unit according to the invention conventionally has a plurality of cells.

### Objects and Summary

The aim of the invention is a unit comprising an electric battery and a casing placed around said battery.

According to the invention, the casing comprises a receptacle and a cover capable of covering said receptacle in order to demarcate an internal space, into which the battery is placed, with the receptacle having nesting means capable of engaging with matching nesting means of said cover, so as to form a continuous and stabilized chain of at least two units. In order to avoid any ambiguity, it is the means for nesting a receptacle of a unit that are capable of engaging with the matching nesting means of the cover of another unit. In this way, units according to the invention each having an electric battery and a casing can be stacked in a particular location, in a stable and space saving manner. The nesting means and the matching nesting means can engage in various ways, such as, for example, by means of a male/female type interaction or by a clipping type interaction. The casing is isolated from the electric current, and therefore allows the battery to be electrically isolated from the outside of the casing. Advantageously, this casing is made of plastic material. Preferably, the casing conforms to the shape of the battery as closely as possible, whilst leaving only a minimum clearance or no clearance therewith. The aim is to prevent the casing from significantly increasing the spatial requirement of the battery.

According to a possible feature of the invention, the nesting means are formed by female type elements and the matching nesting means are formed by male type elements. This interaction can occur through a simple contact so that the male type elements effortlessly slide in the female type elements. It also can occur by force, with the male type elements being inserted into the female type elements with a certain amount of force. It also can involve a clipping type interaction.

According to a possible feature of the invention, the receptacle and the cover are each demarcated by walls providing said receptacle and said cover with a rectangular shape, with the walls of the receptacle each having at least one hollow indentation capable of retaining the cells of the battery in the casing. Each hollow indentation is an element projecting towards the inside of the casing and that allows the cells of the battery to come into contact in order to retain them in a given position inside said casing. Each indentation also forms a reinforcement for stiffening the casing slightly more in the vicinity of the receptacle.

According to a possible feature of the invention, the two parallel walls forming the two large sides of the receptacle each have two hollow indentations, with the two parallel walls forming the two small sides of the receptacle each having a single hollow indentation. This is a particularly effective configuration for retaining the cells of the battery in a stable position in the casing.

According to a possible feature of the invention, the parallel walls forming the two small sides of the receptacle each comprise a handle. Since a unit according to the invention is likely to be transported or moved, it is provided with two handles to help it to be gripped and lifted and with two rows for passing fingers over the large sides.

According to a possible feature of the invention, the cover comprises at least one water drainage trough. Indeed, it is important that water does not stagnate on the cover, in order to prevent any risk of this water penetrating the battery. This trough can be, for example, formed by a groove hollowed into the cover.

According to a possible feature of the invention, the cover is provided with a vent preventing any increase in pressure in the casing. This vent can be, for example, a blank orifice or an orifice provided with a valve set to a certain pressure.

According to a possible feature of the invention, the cover comprises a power-on switch and an indicator light that indicates this powering-on. This switch can be accessed from outside the unit and simply needs to be finger pressed in order to be activated. As soon as the battery is powered-on the indicator light lights up. This indicator light can include at least one LED and can be coloured, for example.

According to a possible feature of the invention, the cover comprises at least one socket to be selected from a charging socket, a discharging socket and a socket for managing the monitoring of said unit. In a unit according to the invention, the charging socket and the discharging socket can be separate or combined.

According to a possible feature of the invention, the cover is fixed to the receptacle using a plurality of screws, with the cover comprising secondary hollow indentations distributed over the periphery of said cover and each intended to accommodate one of said screws. The screws are tamperproof so that an individual who has acquired a unit according to the invention cannot remove the cover from the receptacle and access the battery. These secondary hollow indentations are also used to stiffen the cover.

According to a possible feature of the invention, the cover is mounted on the receptacle by means of a peripheral seal. It is an interface seal located between the cover and the receptacle and that undergoes a crushing force. By being peripheral, the seal is located around the battery and therefore does not interfere therewith.

According to a possible feature of the invention, the receptacle and the cover are manufactured from polypropylene by rotational moulding.

A further aim of the invention is a casing for producing a unit according to the invention.

According to the invention, the casing comprises a receptacle and a cover capable of covering said receptacle in order to demarcate an internal space, into which the battery is intended to be placed, with the receptacle having nesting means capable of engaging with matching nesting means of said cover, in order to form a continuous and stabilized chain of at least two units.

A unit according to the invention has the advantage of being compact, whilst having a plurality of functions that make it universal. Indeed, such a unit equally can be mounted in a fixed installation such as, for example, an industrial site or a house, or on a road or maritime vehicle. It also has the advantage of being robust and of being able to be stacked on at least one other unit in a stable and space saving manner.

### BRIEF DESCRIPTION OF THE DRAWINGS

A detailed description of a preferred embodiment of a unit according to the invention will be provided hereafter, with reference to the following figures, in which:

FIG. 1 shows a perspective bottom view of the receptacle of a unit according to the invention;

FIG. 2 shows a perspective top view of the receptacle of FIG. 1;

FIG. 3 shows a perspective top view of a unit according to the invention;

FIG. 4 shows a perspective top view of two units according to the invention stacked one on top of the other;

FIG. 5 shows a perspective top view of five units according to the invention stacked one on top of the other.

### DETAILED DESCRIPTION

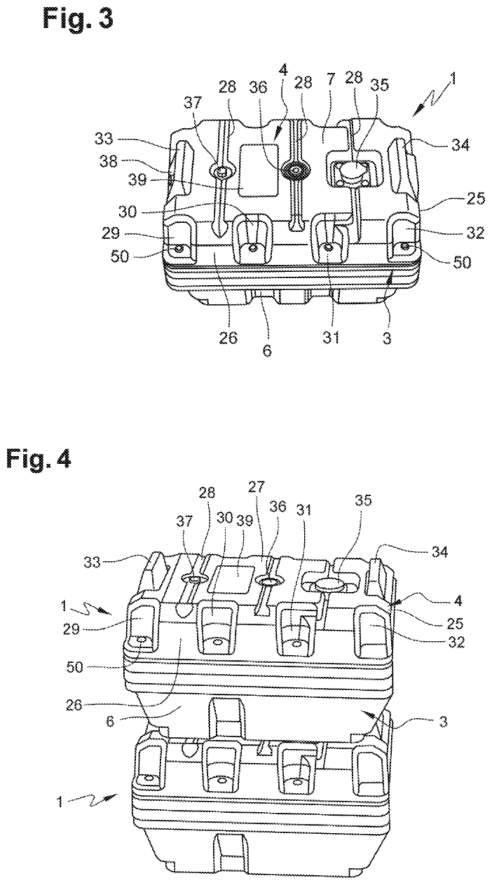

With reference to FIGS. 3, 4 and 5, a unit 1 according to the invention comprises an electric battery made up of a plurality of electric cells, and a casing surrounding said electric battery. This casing comprises a receptacle 3 and a cover 4, said cover 4 being intended to cover said receptacle 3 to demarcate an internal space provided to house the electric battery.

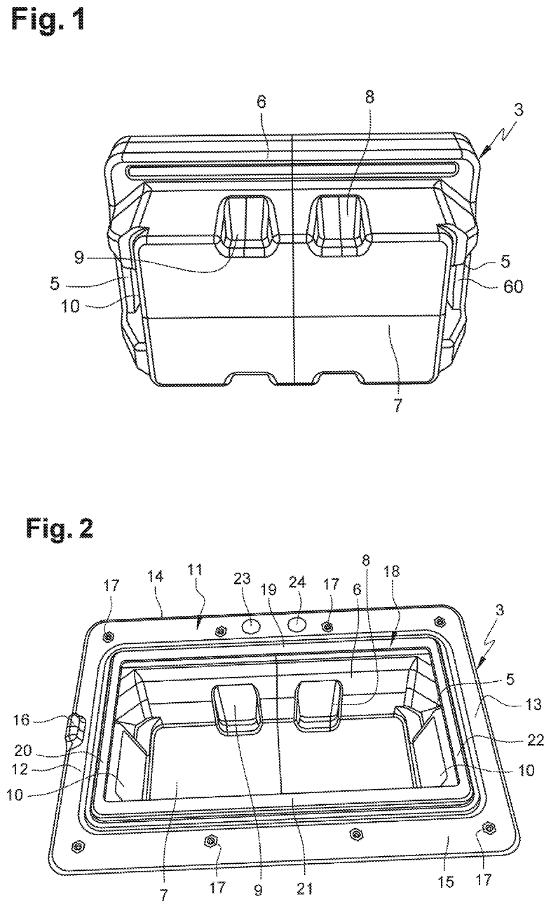

With reference to FIGS. 1 and 2, the receptacle 3 is schematically demarcated by four walls 5, 6 defining a rectangular profile, and by a base 7. Two 6 of said walls are elongated and parallel, and form the large sides of the rectangle, with the other two walls 5 being short and parallel, and forming the small sides of said rectangle. Each of the two elongated walls 6 has two hollow indentations 8, 9 aligned along a longitudinal axis of said wall 6. Each hollow indentation 8, 9 is comparable to a boss projecting towards the inside of the receptacle 3. Each of the two short walls 5 also comprises a hollow indentation 10 comparable to a boss projecting towards the inside of the receptacle 3. The hollow indentations 8, 9, 10 of the walls 5, 6 demarcating the receptacle 3 are used to stiffen said receptacle 3 and to keep the electric cells of the battery in a given position in the casing 2.

With reference to FIG. 2, the receptacle 3 has a flat interface frame 11 made up of four folded edges 12, 13, 14, 15 of the four walls 5, 6 demarcating said receptacle 3. These edges 12, 13, 14, 15 thus extend the four walls 5, 6 by being folded at 90° relative to said walls 5, 6, so that they define a flat frame 11 that is perpendicular to these walls 5, 6. This frame 11 comprises a locator 16 in the form of a boss projecting from one 12 of the two short edges of said frame 11, said locator 16 allowing the cover 2 to be mounted on the receptacle 3 in only one manner. Each of the two elongated edges 14, 15 of the frame 11 has a series of four blind inserts 17 made of brass that are evenly spaced apart along said elongated edge 14, 15. The frame 11 demarcates a rectangular channel 18 having a base in the form of four flat segments 19, 20, 21, 22 parallel to the edges 12, 13, 14, 15 of the frame 11, whilst being slightly offset thereto. In other words, the channel has a base in the form of a flat secondary frame that is parallel to the interface frame 11, whilst being slightly offset thereto. The receptacle 3 also has, on one of the two elongated edges 14, 15 of the interface frame 11, two date markers 23, 24 that indicate the EC certification, the nature of the composition of the casing surrounding the battery, the month and the year of manufacture, as well as any information for characterizing and/or identifying a unit 1 according to the invention. The receptacle 3 also has, on each of the two short walls 5, a female notch 60 and a handle to help grip a unit 1 according to the invention. The receptacle 3 is preferably manufactured from PP46 polypropylene by rotational moulding. It has a single 4 mm thick skin.

With reference to FIGS. 3 and 4, the cover 4 is schematically demarcated by four walls 25, 26 defining a rectangular profile and by a ceiling 27. Two 26 of said walls are elongated and parallel and form the large sides of the rectangle, with the other two walls 25 being short and parallel and forming the small sides of said rectangle. The ceiling 27 has three troughs 28 parallel to the short walls 25 and passing through said ceiling 27. These troughs 28 advantageously are produced in the form of three grooves hollowed into the ceiling 27 and evenly spaced apart along a longitudinal axis of the cover 4. Once the cover 4 is fixed to the receptacle 3, the troughs 28 are outside the casing 2 and are intended to discharge water, such as rain water, for example. Each elongated wall 26 of the cover 4 comprises four hollow secondary indentations 29, 30, 31, 32 that are evenly spaced apart along a longitudinal axis of said elongated wall 26. Each hollow secondary indentation 29, 30, 31, 32 is comparable to a boss projecting towards the inside of the cover 4. Each hollow secondary indentation 29, 30, 31, 32 has a base, through which an M6 type screw 50 passes. The ceiling 27 of the cover 4 has two protuberances 33, 34 placed in the vicinity of the two short walls 25 and extending along said short walls 25. These protuberances 33, 34 are installed on an external surface of the cover 4 and therefore project towards the outside of said cover 4. A charging socket 35, a power-on switch 36 associated with an indicator light, which will turn on as soon as the switch 36 is placed in a position corresponding to this powering-on, and a vent 37 for preventing any pressurization inside the casing 2 emerge from the ceiling 27 of the cover 4. Said vent appears, for example, in the form of a small orifice, which can be associated, for example, with a valve set to a given pressure. The cover 4 also comprises a discharge socket 38 placed on one of the two short walls 25 and an identification plate 39 placed on an external surface of said cover 4. This cover 4 preferably is manufactured from PP46 polypropylene by rotational moulding and advantageously has two skins.

Like the receptacle 3, the cover 4 has a flat, rectangular shaped interface frame demarcating a rectangular channel having a base in the form of four flat segments parallel to the edges of said interface frame, whilst being slightly offset thereto. In other words, the channel has a base in the form of a flat secondary frame, which is parallel to the interface frame, whilst being slightly offset thereto.

The battery is placed in the receptacle 3, then the cover 4 covers said receptacle 3, thereby confining said battery. A 6 mm thick ring type seal is placed in the channel 18 of the receptacle 3. The cover 4 is closed over the receptacle so that said seal is housed in the channel of the cover 4 and so that the screws 50 of the cover 4 are each screwed into a blind insert 17 of the receptacle 3. In this way, the resulting casing surrounding the battery is sealed and tamperproof, since an individual cannot access the screws 50 in order to separate the cover 4 and the receptacle 3.

Once a unit 1 according to the invention has been manufactured, it can be easily handled and/or moved by an individual, who can grip the handles of the receptacle 3.

With reference to FIG. 4, two units 1 according to the invention can be stacked one on top of the other in a stable manner, by inserting the two protuberances 33, 44 of the cover 4 of the lower unit 1 into the two female notches 60 of the receptacle 4 of the upper unit 1. This insertion of the protuberances 33, 44 into the notches 60 ensures the mounting stability of the stack of two units 1, in a horizontal interface plane between said two units 1.

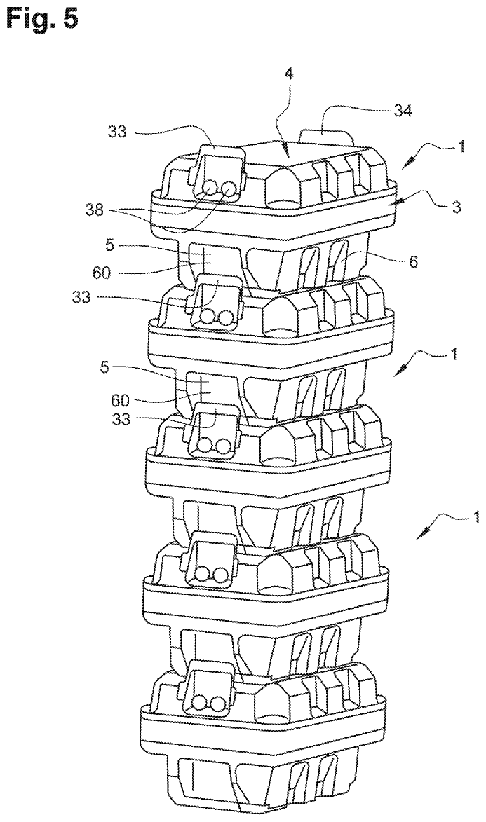

With reference to FIG. 5, the aforementioned stack is not only limited to two units 1, but can be extended to a plurality of units 1, including more than two units, such as, for example, five units, as illustrated in FIG. 5.

1. A unit comprising:
an electric battery; and
a casing placed around said battery,
wherein the casing has a receptacle and a cover capable of covering said receptacle in order to demarcate an internal space, into which the battery is placed, and in that the receptacle has nesting means capable of engaging with matching nesting means of said cover, so as to form a continuous and stabilized chain of at least two units.

2. The unit according to claim 1, wherein the nesting means are formed by female type elements and the matching nesting means are formed by male type elements.

3. The unit according to claim 1, wherein the receptacle and the cover are each demarcated by walls providing said receptacle and said cover with a rectangular shape, and in that the walls of the receptacle each have at least one hollow indentation capable of retaining the cells of the battery in the casing.

4. The unit according to claim 3, wherein the parallel walls forming the two small sides of the receptacle each comprise a handle.

5. The unit according to claim 1, wherein the cover comprises at least one water drainage trough.

6. The unit according to claim 1, wherein the cover is provided with a vent preventing any increase in pressure in the casing.

7. The unit according to claim 1, wherein the cover comprises a power-on switch and an indicator light that indicates this powering-on.

8. The unit according to claim 1, wherein the cover comprises at least one socket to be selected from a charging socket, a discharging socket and a socket for managing the monitoring of said unit.

9. The unit according to claim 1, wherein the cover is fixed to the receptacle using a plurality of screws, and in that the cover comprises secondary hollow indentations distributed over the periphery of said cover and each intended to accommodate one of said screws.

10. The unit according to claim 1, wherein the cover is mounted on the receptacle by means of a peripheral seal.

11. The unit according to claim 1, wherein the receptacle and the cover are manufactured from polypropylene by rotational moulding.

12. A casing for producing a unit according to claim 1, wherein the casing has a receptacle and a cover capable of covering said receptacle in order to demarcate an internal space, into which the battery is intended to be placed, and in that the receptacle has nesting means capable of engaging with matching nesting means of said cover, in order to form a continuous and stabilized chain of at least two units.
